(19) United States
(12) Patent Application Publication
(10) Pub. No.: US 2014/0206440 A1
(43) Pub. Date: Jul. 24, 2014

(54) GAME SYSTEM AND GAMING METHOD HAVING IDENTIFICATION FUNCTION

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: LIN LIU, Shenzhen (CN)

(73) Assignees: HON HAI PRECISION INDUSTRY CO., LTD., New Taipei (TW); HONG FU JIN PRECISION INDUSTRY (shenZhen) CO., LTD ., Shenzhen (CN)

(21) Appl. No.: 13/860,543

(22) Filed: Apr. 11, 2013

(30) Foreign Application Priority Data
Jan. 24, 2013 (CN) 201310026492.7

(51) Int. Cl. A63F 13/00

(52) U.S. Cl. CPC A63F 13/00
USPC 463/29

(57) ABSTRACT

A game system with an identification function. A fingerprint sensor reads fingerprint information of a game player and outputs the fingerprint information to a processor through first and second BLUETOOTH modules. The processor compares the received fingerprint information with play information, which is obtained from a database of a cloud game system through a wireless network module. If the fingerprint information is stored in the database, the game console finds and displays games played by the game player, the schedule of the games, and operation options of the games. If the fingerprint information is not stored in the database, the game console stores the fingerprint information, the games played by the game player, and the operation options of the games in the database through the wireless network module. A gaming method having identification function is also disclosed.

### BACKGROUND

1. Technical Field

The present disclosure relates to game systems and gaming methods, and particularly to a game system and a gaming method having identification function.

2. Description of Related Art

When most generic game machine is used, the preferred games of the players need to be selected manually and the operation options of the games also need to be selected manually, which may be time-consuming and complicated.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments.

FIG. 1 is a block diagram of a game system having identification function in accordance with an embodiment of the present disclosure.

FIG. 2 is a flowchart of a gaming method having identification function in accordance with an embodiment of the present disclosure.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

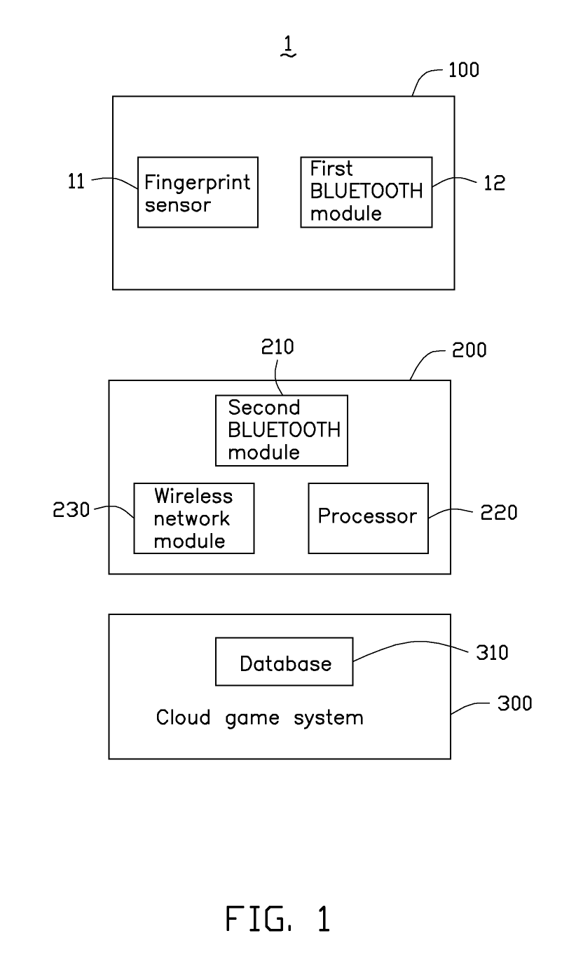

FIG. 1 shows a game system 1 in accordance with an embodiment. The game system 1 includes an identification function, as well as a game handle 100 and a game console 200. The game handle 100 includes a fingerprint sensor 11 and a first BLUETOOTH module 12.

Other elements of the game handle 100 are the same as a generic Wii™ game handle. The game console 200 includes a second BLUETOOTH module 210, a processor 220, and a wireless network module 230. Other elements of the game console 200 are the same as a generic Wii™ game console.

The fingerprint sensor 11 reads fingerprint information, such as a fingerprint information of a right hand of a game player, and outputs the fingerprint information to the processor 220 through the first and second BLUETOOTH modules 12 and 210. The processor 220 compares the received fingerprint information with player information, which is obtained from a database 310 of a cloud game system 300 through the wireless network module 230. Wherein the cloud game system 300 is a virtual storage system for storing data. If the fingerprint information is stored in the database 310 of the cloud game system 300, the game console 200 automatically finds and displays the games played by the game player, the schedule of the games, and the operation options of the games, and also recommends some games to the game player according to the games played by the game player. If the fingerprint information is not stored in the database 310 of the cloud game system 300, the game console 200 stores the fingerprint information, the games played by the game player, and the operation options of the games in the database 310 of the cloud game system 300 through the wireless network module 230.

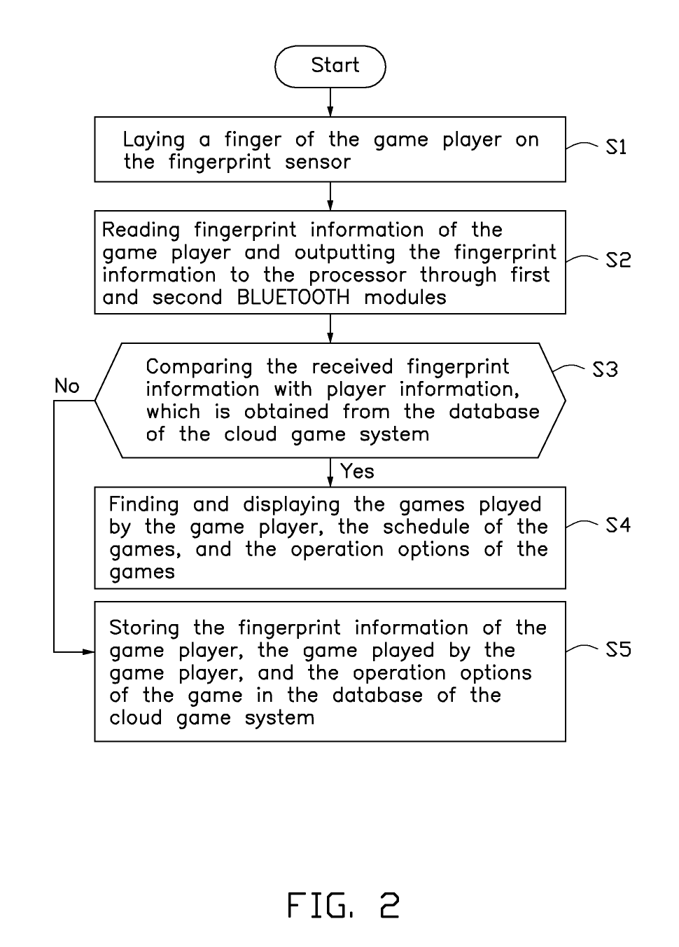

FIG. 2 shows a gaming method with identification function in accordance with an embodiment of the present disclosure includes the following steps.

In step S1, laying a finger, such as a finger of a right hand of the game player, on the fingerprint sensor 11.

In step S2, the fingerprint sensor 11 reads the fingerprint information of the game player and outputs the fingerprint information to the processor 220 through the first and second BLUETOOTH modules 12 and 210.

In step S3, the processor 220 compares the received fingerprint information with the player information, which is obtained from the database 310 of the cloud game system 300, if the fingerprint information is stored in the database 310 of the cloud game system 300, the procedure go to step S4, if the fingerprint information is not stored in the database 310 of the cloud game system 300, the procedure go to step S5.

In step S4, the game console 200 automatically finds and displays the games played by the game player, the schedule of the games, and the operation options of the games, and also recommends some games to the game player according to the games played by the game player.

In step S5, the game console 200 stores the fingerprint information, the games played by the game player, and the operation options of the games in the database 310 of the cloud game system 300 through the wireless network module 230.

The game system 1 obtains the fingerprint information of the game player through the game handle 100 and outputs the fingerprint information to the game console 200. The game console 200 obtains the identification of the game player according to the fingerprint information, to allow the game player to select preferred games and can continue to play conveniently.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A game system having identification function, the game system comprising:
a game handle comprising:
a fingerprint sensor; and
a first BLUETOOTH module; and
a game console comprising:
a second BLUETOOTH module;
a processor; and
a wireless network module;
wherein the fingerprint sensor reads a fingerprint information of a game player and outputs the fingerprint information to the processor through the first and second BLUETOOTH modules, the processor compares the received fingerprint information with play information, which is obtained from a database of a cloud game system through the wireless network module, upon a condition that the fingerprint information is stored in the database of the cloud game system, the game console finds and displays games played by the game player, the schedule of the games, and operation options of the games; upon a condition that the fingerprint information is not stored in the database of the cloud game system, the game console stores the fingerprint information, the games played by the game player, and the operation options of the games in the database of the cloud game system through the wireless network module.

2. A gaming method having identification function, the game method comprising:
laying a finger of a game player on a fingerprint sensor of a game handle;
reading fingerprint information of the game player and outputting the fingerprint information to a processor through a first BLUETOOTH module of the game handle and a second BLUETOOTH module of a game console;
comparing the received fingerprint information with player information which is obtained from a database of a cloud game system;
finding and displaying the games played by the game player, the schedule of the games, and the operation options of the games in response to the fingerprint information being stored in the database of the cloud game system; and
storing the fingerprint information of the game player, the games played by the game player, and the operation options of the games in the database of the cloud game system in response to the fingerprint information being not stored in the database of the cloud game.

3. The game method of claim 2, further comprising:
recommending some games to the game player according to the games played by the game player, in response to the fingerprint information being stored in the database of the cloud game system.
